(19) United States
(12) Patent Application Publication
(10) Pub. No.: US 2003/0053044 A1
(43) Pub. Date: Mar. 20, 2003

(54) Color balance control in organic light emitting diode displays

(75) Inventors: Zoran D. Popovic, Mississauga (CA); John F. Graham, Oakville (CA); Hany Aziz, Burlington (CA); Nan-Xing Hu, Oakville (CA)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 09/954,256

(22) Filed: Sep. 18, 2001

(51) Int. Cl. G01J 1/42

(52) U.S. Cl. 356/218

(57) ABSTRACT

A system and method are provided for measuring the average light levels from a flat panel display for use in a brightness compensating system. One or more photodiodes are disposed outside of the display area of a flat panel display so as to measure the average light levels directly or via total internal reflection through the transparent substrate of the display. The measured light levels are then used to provide a baseline for calibrating the color balance and brightness of the display using the brightness compensating system.

### FIELD OF INVENTION

This invention relates generally to light emitting flat panel displays, and more particularly to a method of sensing light at the edges of an organic light emitting diode (OLED) display for use in color correction control circuitry.

### BACKGROUND OF THE INVENTION

Organic light emitting diodes (OLEDs) operate by passing a current through organic materials to generate light via electroluminescence. The brightness of each pixel is proportional to the current applied through it, although with time and usage the organic material comprising the light emitting diode degrades such that the current needed for the organic material to emit a given brightness level increases with time, as discussed in greater detail below.

One advantage of OLEDs over conventional liquid crystal display (LCD) and deformable-mirror display (DMD) devices is that OLEDs are emissive, thereby eliminating the requirement for back lighting. An advantage of such displays over conventional cathode ray tube (CRT) displays is that displays fabricated using OLEDs are of lightweight design and are thin (as thin as 1 mm according to present design methodologies).

One challenge facing developers of OLED displays is to maintain color balance in response to differential aging characteristics of the materials used to generate the different primary colors (i.e. red, green and blue). As discussed briefly above, in order to maintain a given level of light over time, increased driving current must be applied to the light emitting material. However, the organic materials used to generate light at different wavelengths (i.e. colors) degrade at different rates. For example, state-of-the-art green organic pixels have a half-life of approximately 100,000 hours at a typical brightness level of a computer monitor (e.g. 100 Cd/m²), (J. Shi and C. W. Tang, Appl. Phys. Lett. 70, 1665 (1997), and S. A. Van Slyke, C. H. Chen and C. W. Tang, Appl. Phys. Lett. 69, 2160 (1996)) whereas blue organic pixels reach their half-life after only 10,000 hours (C. Hosokawa et al., Journal of the SID, 5/4, 331-334 (1997)). This results in a 10% deviation in color balance (disregarding aging of the red organic materials) after only about 1000 hours of use, on the assumption that these two colors were properly balanced at the time of display fabrication.

### SUMMARY OF THE INVENTION

According to the present invention, a system and method are provided for measuring the average light levels from a flat panel display for use in a brightness and color balance compensating system. The compensating system does not form part of the present invention and would be well known to a person of ordinary skill in the art. Such a system may include, for example, a closed loop digital system for differentially adjusting the current applied to the organic light emitting pixels for the three primary colors based on the measured brightness levels for these colors as detected by the system of the present invention.

Although in principle individual brightness levels could be obtained for each pixel in the display, such a detection arrangement would require a vast number of detectors, thereby rendering such a system complicated and unpractical.

Therefore, according to the present invention one or more photodiodes are disposed outside of the display area of a flat panel display so as to measure the average light levels (i.e. across the entire display, rather than on a per pixel basis). The measured light levels are then used to provide a baseline for calibrating the color balance of the display using a brightness compensating system as is known in the art.

In one embodiment of the invention, the photodiodes are mounted along the edges of the glass substrate of the display to provide a measure of the average light intensity due to light reaching the photodiodes either directly or as a result of total internal reflection through the glass. In another embodiment, the photodiodes are mounted outside of the viewing area on the surface of the glass substrate.

### BRIEF DESCRIPTION OF THE DRAWINGS

A detailed description of the invention is set forth herein below, with reference to the accompanying drawings, in which:

FIG. 1 is a schematic representation of a system for measuring the average light levels from a flat panel display in accordance with a first embodiment of the invention;

FIG. 2 is a circuit diagram of a passive matrix type OLED flat panel display according to the prior art, to which the system of the present invention is applied;

FIG. 3 is a schematic elevation view of an OLED pixel for the flat panel of FIG. 2; and

FIG. 4 is schematic representation of a system for measuring the average light levels from a flat panel display in accordance with a second embodiment of the invention.

### DETAILED DESCRIPTION

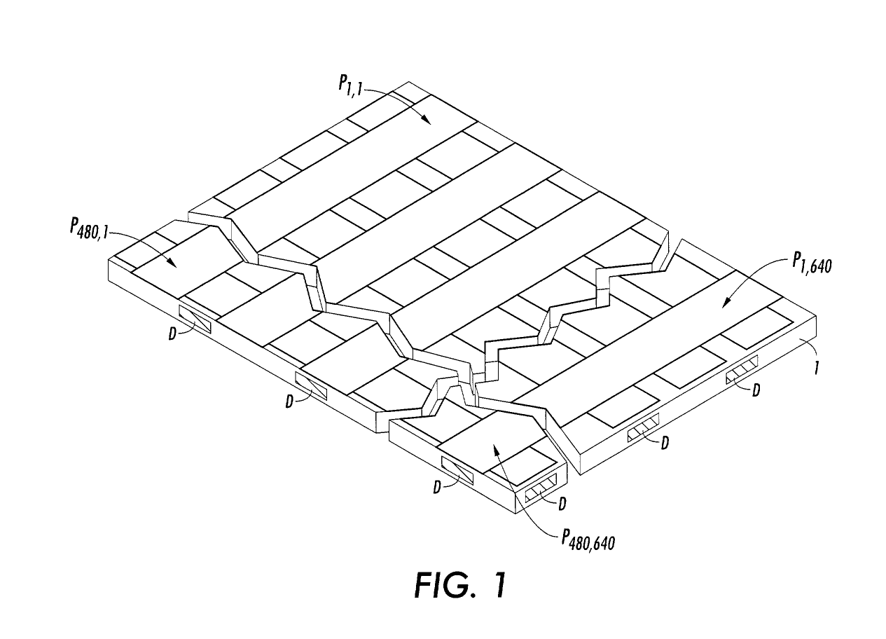

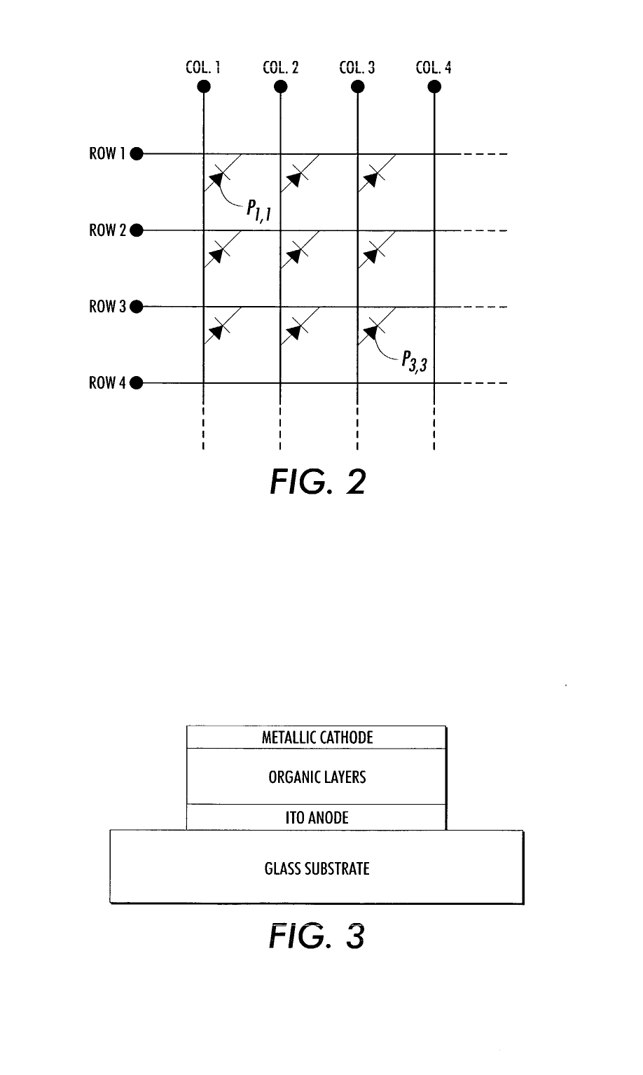

Referring to FIG. 1, a system is shown for measuring the average light levels from a flat panel display in accordance with a first embodiment of the invention. The flat panel display is mounted on a glass substrate 1. Alternatively, a transparent plastic substrate may be used for greater impact resistance and flexibility. A plurality of pixels P₁, ₁ . . . P_{1, 640} to P_{480, 1} . . . P_{480, 640} are arranged in a matrix to form a 640×480 pixel display (i.e. a VGA display), as is common in the art. The array of pixels is addressed using a passive matrix addressing scheme of column and row drivers (see Ching W. Tang, U.S. Pat. No. 5,276,380 for monochrome displays, Ching W. Tang and Jon E. Littman, U.S. Pat. No. 5,294,869 for colour displays, Satoshi Miyaguchi et al., Journal of the SID 7/3, 221-226 (1999), for color displays). In a passive matrix driving scheme pixels are formed by intersecting column and row electrodes, as schematically presented in FIG. 2. The individual organic light emitting diodes (OLED) are addressed by the column and row drivers applying electrical pulses on the row and column electrodes (Ching W. Tang, U.S. Pat. No. 5,276,380, Satoshi Miyaguchi et al., Journal of the SID 7/3, 221-226 (1999)). A typical structure of an OLED is presented in FIG. 3. The operating principle of the passive matrix driving scheme and the physical structure of the OLED is set forth in greater detail below with reference to FIGS. 2 and 3.

According to the present invention as depicted in FIG. 1, a plurality of photodiodes D are disposed along the edges of glass substrate 1 (although the principles of the invention may be effected with only a single such photodiode D). It is well known that, in accordance with the law of total internal reflection, only approximately 20% of light generated by the display of FIG. 1 escapes though the surface of the glass (see G. Gu et al., Optics Letters 22, 396-398 (1997)). Most of the generated light is either absorbed or reflected internally and exits via the edges.

The photodiodes D are silicon photodiodes, but any other type of photodiodes with suitable spectral characteristics (e.g. fabricated from organic material) can also be used. Where crystalline silicon photodiodes are used, the photodiodes D are mounted to the edges via an index-matching medium so as to approximate the index of refraction of the substrate thereby leading to transmission of light to the photodiodes, instead of total internal reflection. The photodiodes are bonded to the edges using a transparent adhesive. A large number of adhesives with proper index of refraction and transmission characteristics are available, such as products offered by Epoxy Technology of Billerica, Mass. USA.

In operation, in order to accomplish color balance calibration, the column and row drivers of the flat panel display cause sequential flashing of the three primary colors on power-up of the display or after the display has been on for a predetermined length of time. The length of the calibrating display flash can be as short as one display refresh cycle, or longer if larger measuring accuracy is needed. All red pixels may be flashed, followed by all green pixels and then all blue pixels. The average brightness levels for the three primary colors are measured by the photodiodes D for use in a brightness and color balance compensating system, such as described for example in Hansen, et al. U.S. Pat. Nos. 6,037,918 and 5,898,415.

Alternatively, instead of performing three sequential color brightness measurements, red, green, and blue color filters may be applied to the plurality of photodiodes D for isolating the three primary colors and the display may be caused to flash white only once.

Although FIGS. 2 and 3 represent background information only, they are included herein to provide a clear description of an application of the present invention. With reference to FIG. 2, a particular pixel is addressed by the row and column drivers applying a energizing voltages to the associated row line (Row 1, Row 2, etc.) and column line (Col. 1, Col. 2, etc.). The potential difference between the electrodes of the addressed pixel is chosen such that the pixel emits light, while the potential difference between electrodes of all other pixels is maintained below the light emission threshold (see Satoshi Miyaguchi et al., Journal of the SID 7/3, 221-226 (1999)). Usually the pixels along the entire row line are written at one time by placing appropriate voltages on all of the column lines in the array during the line addressing time.

Although the present invention is described and depicted herein with reference to a passive matrix addressing scheme, the invention may also be used for brightness and color balance control in an active matrix addressing scheme (see for example, Andrew Gordon Francis Dingwall U.S. Pat. No. 5,903,246, and Ronald Roy Troutman, U.S. Pat. No. 6,157,356).

The structure of a typical OLED is depicted in FIG. 3. Generally, the display fabrication process begins with formation of a substrate containing a plurality of electrodes and the circuitry for driving and selecting the pixels (FIG. 2). Typically, the plurality of semi-transparent indium tin oxide (ITO) anode electrodes is deposited onto a glass or other suitable transparent substrate. The individual red, green and blue OLEDs are integrated with the addressing matrix array (Ching W. Tang and Jon E. Littman, U.S. Pat. No. 5,294,869) and after deposition of the cathode the completed panel is assembled and tested (typically including an initial factory-preset color balance calibration). As for the fabrication of the OLEDs themselves, one or more organic layers are deposited on the patterned substrate. A cathode is formed on top by depositing a suitable metal (e.g. magnesium/silver alloy, lithium/aluminum alloy, calcium, etc., with silver or other metal protective capping).

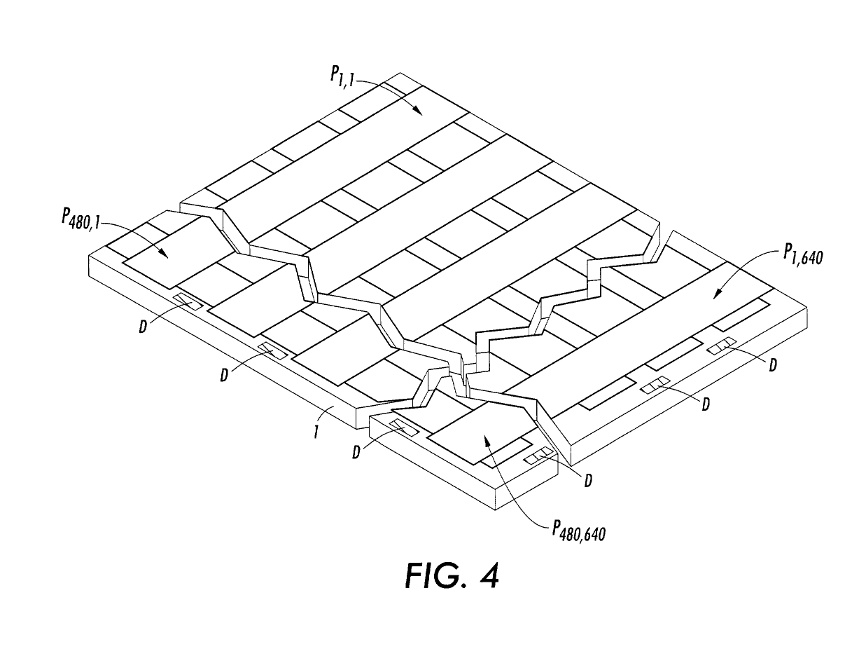

With reference to FIG. 4, a second embodiment of the invention is shown wherein the photodiodes D are disposed on the surface of the glass substrate (rather than on the edges) outside of the useable display area. Where crystalline silicon photodiodes are used, an approximate index matching medium ensures that light received from within the glass substrate is not internally reflected but is, instead, received by the surface mounted photodiodes D, as discussed above in connection with the embodiment of FIG. 1. Where polysilicon or amorphous silicon photodiodes are used, the photodiodes D are integrated into the display structure at the time of display fabrication.

Variations and modifications of the invention are contemplated. For example, the photodiodes D may either be mounted (as discussed above) or integrated onto the glass substrate using well known polysilicon, amorphous silicon, or organic-based photodiodes. Also, although the invention has been described in connection with OLED displays (which exhibit greater color imbalances than other flat panel displays), the inventive system may be used with all manner of active or passive organic or inorganic flat panel displays where aging is detrimental to color balance. The present method can also be used in monochrome displays to calibrate display brightness. All such modifications and alternative embodiments are believed to fall within the sphere and scope of the invention as defined by the appended claims.

What is claimed is:

1. A system for measuring average light output from a flat panel display having a transparent substrate and a plurality of pixels mounted on a viewing area thereof, said system comprising driver circuitry for causing pixels of said display to generate light, and at least one photodiode mounted on said transparent substrate outside the viewing area thereof for detecting said light generated by said display via at least one of total internal reflection or directly through said transparent substrate.

2. The system of claim 1, wherein said at least one photodiode is mounted to an edge of said transparent substrate.

3. The system of claim 1, wherein said at least one photodiode is mounted to a surface of said transparent substrate outside of said viewing area.

4. The system of claim 1, wherein said at least one photodiode is mounted to said transparent substrate using an index matching medium.

5. The system of claim 4, wherein said index matching medium is a bonding adhesive.

6. The system of claim 1, wherein pixels of said flat panel display are fabricated from organic light emitting diodes.

7. The system of claim 1, further comprising at least three photodiodes with filters for isolating primary red, green and blue colors detected by said photodiodes.

8. A method of measuring average light output from a flat panel display, comprising:
mounting at least one photodiode on a transparent substrate of said flat panel display outside the viewing area thereof; and
flashing said display such that said at least one photodiode detects light generated by said display.

9. The method of claim 8, wherein red, green and blue pixels of said display are flashed in succession.

10. The method of claim 8, wherein red, green and blue pixels of said display are flashed in unison so as to generate white light.

11. The system of claim 1 wherein the transparent substrate is made of glass.

12. The system of claim 1 wherein the transparent substrate is made of plastic.

13. The system of claim 1, wherein pixels of said flat panel display are fabricated from inorganic light emitting diodes.

14. The system of claim 3, wherein said at least one photodiode is integrated into said display directly on said surface of said transparent substrate.

15. The system of claim 14 wherein said at least one photodiode is made of polysilicon.

16. The system of claim 15 wherein said at least one photodiode is made of amorphous silicon.

17. The system of claim 15 wherein said at least one photodiode is made of organic material.

18. The system of claim 5, wherein said at least one photodiodes is made of crystalline silicon.
